(19) United States
(12) Patent Application Publication
(10) Pub. No.: US 2007/0033122 A1
(43) Pub. Date: Feb. 8, 2007

(54) Method and apparatus for computing selection criteria for an automated valuation model

(75) Inventor: Christopher L. Cagan, Los Angeles, CA (US)

Correspondence Address: SNELL & WILMER LLP, 600 ANTON BOULEVARD, SUITE 1400, COSTA MESA, CA, 92626, US

(73) Assignee: First American Real Estate Solutions, LP

(21) Appl. No.: 11/197,653

(22) Filed: Aug. 4, 2005

(51) Int. Cl. G06Q 40/00

(52) U.S. Cl. 705/35

(57) ABSTRACT

A method and apparatus for ranking automated valuation model valuations. The method and apparatus involves a multi-step process and means for completing this process for calculating an automated valuation model score and then ranking the automated valuation models for precision based upon the results of this calculation.

The present invention is an improvement upon the prior non-provisional patent application entitled Method and Apparatus For Real Time Testing of Automated Valuation Models filed Dec. 8, 2004 with Ser. No. 11/007,750 which is owned by the assignee of this invention.

1. Field of the Invention

The present invention relates to real estate valuation and more specifically to a method and apparatus for systematically rating and ranking automated valuation models. The method and apparatus of this invention provides a means to rate and rank automated valuation models for precision with respect to several attributes, in any subset of properties for which real estate valuations may be provided.

2. Background of the Invention

Real estate valuations are more often being completed using advanced computer algorithms based on databases. These algorithms are called automated valuation models (AVM or AVMs). These AVMs are useful in providing estimates of value for real property for several reasons. Most notably, they are typically substantially less expensive than an appraisal. Additionally, they are much faster, usually only requiring a matter of seconds or at most minutes before they are complete. Finally, these automated valuation models are typically fairly accurate estimates of value for properties. For these and other reasons, automated valuation models (AVMs) are being used more frequently in real estate valuation.

The number of commercial products being offered as automated valuation models is large. There are multiple providers and each automated valuation model has its own method of determining its accuracy. Each AVM usually has some indication of its accuracy in terms of a “confidence score” but none of these confidence scores are compatible with each other or calculated in the same way. To further complicate things, particular AVMs may be more accurate in a given geographic area, price bracket or other set or subset of properties while being fairly inaccurate in others.

Therefore, there exists needed in the art an invention which is useful and systematic for rating and ranking automated valuation models. The confidence scores provided by automated valuation models are not particularly useful for comparing automated valuation models because of their inconsistency with one another. This invention improves on the prior art by providing a systematic method of rating and ranking automated valuation models. The method and apparatus of this invention may also be utilized to rank non-automated valuations of properties, such as appraisals. It provides a method by which automated valuation models may be scored in geographic areas, price tiers, or any other viable sub-set of properties for which a property valuation may be provided by an automated valuation model. This invention further improves upon previous inventions by providing several new and novel features.

### BRIEF SUMMARY OF THE INVENTION

According to the present invention, a method and apparatus are described whereby automated valuation models are rated and ranked for precision using multiple attributes, each useful indicators of an AVM's usefulness in valuing properties. Various automated valuation model ranking criteria are used. In the preferred embodiment, four main concepts are used. The automated valuation models are ranked according to their hit rate, centrality, accuracy and outliers. These terms have specific meanings with relation to the preferred embodiment of this invention, but one or more may be altered or removed without varying from general scope and subject matter of the present invention.

### BRIEF DESCRIPTION OF THE DRAWING

FIG. 1 is a block diagram depiction of an example data structure upon which the method of this invention can be performed.

FIG. 2 is a flow-chart depicting the steps involved in the preferred embodiment of the method of calculating an automated valuation model ranking.

FIG. 3 is a depiction of the hit rate calculation for the example automated valuation models.

FIG. 4 is a depiction of the useful hit rate and hit score calculation for the example automated valuation models.

FIG. 5a is a depiction of the calculations used to determine centrality and center score for a state.

FIG. 5b is a depiction of the calculations used to determine centrality and center score for another state.

FIG. 5c is a depiction of the calculations used to determine centrality and center score for another state.

FIG. 6a is a depiction of the centrality and center score calculations for the example automated valuation models for a state.

FIG. 6b is a depiction of the centrality and center score calculations for the example automated valuation models in another state.

FIG. 6c is a depiction of the centrality and center score calculations for the example automated valuation models in another state.

FIG. 7 is a depiction of the numerical calculations to be used in determining accuracy and accuracy score.

FIG. 8a is the left side of a table depicting the calculation of accuracy and accuracy score for a state.

FIG. 8b is the right side of a table depicting the calculation of accuracy and accuracy score for a state.

FIG. 9 is a depiction of the percentages at particular outlier variance levels.

FIG. 10 is a depiction of the outlier points granted for each percent of outlier variances and of the total outlier points.

FIG. 11 is a depiction of the state of the art approach to the calculation of outlier points and the calculation of a final score.

FIG. 12 is a depiction of a “quality score” and ranking calculation table using an alternative embodiment of the present invention.

### DETAILED DESCRIPTION OF THE INVENTION

The present invention provides a method and apparatus for the calculation of an automated valuation model ranking. The method of this invention may also be applied to appraisals done by a particular individual or group, but its application is most readily useful in ranking automated valuation model valuations. The method and apparatus of this invention are systematic and logical. The invention represents a significant improvement over the prior art.

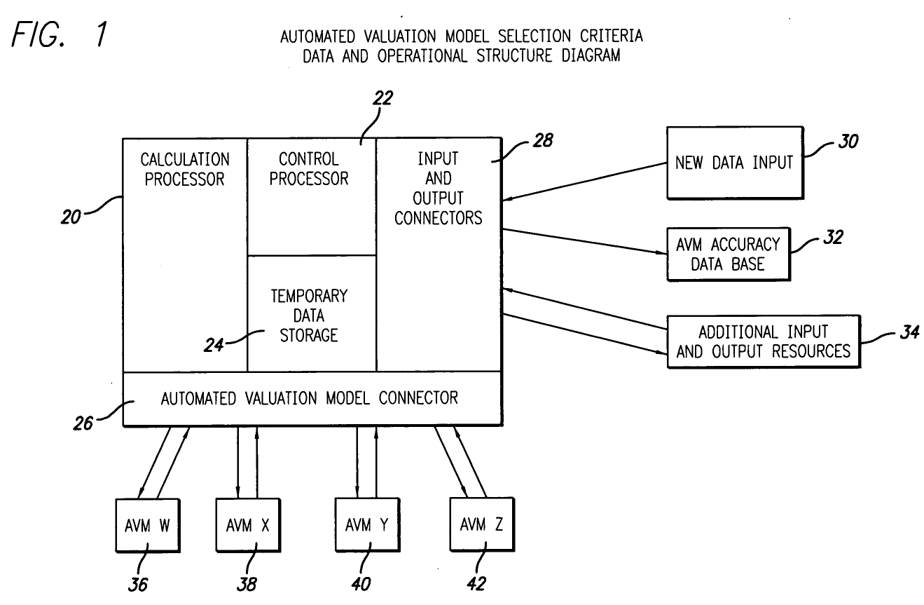

Referring first to FIG. 1, an example data structure upon which the method of this invention may take place is displayed. The data structure depicted is only an example and may be varied dependent upon the specific embodiment of the method and apparatus used. The data and operational structure of this invention may be implemented in software or hardware, though in the preferred embodiment, software is used. In this example there are various data and operational structure elements. The first element is the calculation processor 20. This represents the capability of the invention used to perform calculations, such as determining the hit rate for a particular automated valuation model. In the preferred embodiment, it also is responsible for performing all other relevant calculations related to the present invention.

Next, the control processor 22 is depicted. In the preferred embodiment, this element is responsible for over-arching control of the data flow into and out of this example data structure. It also controls and houses the relevant method data, such as the order of operations or computer programming necessary to instruct a computer to perform the method of this invention. Next, is the temporary data storage 24. This element's task is to store the relevant data, temporarily, while it is being worked on by the invention. If the example apparatus were created using hardware, this would be a portion of random access memory or other hardware-based temporary memory. If this example were created using software, as in the preferred embodiment, it would be a portion of memory, allocated by the operating system, to the program as it performs its various functions. Example data that may be stored herein could include: hit rate percentages, hit scores, outlier percentages pertaining to a particular automated valuation model and the code of the method of this invention that is being executed by the operating system.

The next element is the input and output connectors 28. These may be one or more than one interface useful in communicating outside of the data and organizational structure. In the preferred embodiment, there are interfaces designed to enable communication with new data input 30, an automated valuation model accuracy database 32 and additional input and output resources 34. These input and output connectors 28 may be designed only to receive or only to send data. Alternatively, there may be other input and output connectors or portions thereof that may send and receive data to one source. For example, the new data input 30 is a source of new data pertaining to the automated valuation models to be ranked. The automated valuation model accuracy database 32 is a database to which the rankings and all data calculated pertaining to a particular ranking is stored. This automated valuation model accuracy database 32 may be one or more databases, but is depicted as a single database here for simplicity. Finally, the additional input and output resources 34 include any and all other connections this example apparatus may need in order to operate. Examples of this type of connection could include a printer, a keyboard, and additional databases containing relevant data or to which ranking data or portions of ranking data is sent or any other useful connection.

Finally, there is an automated valuation model connector 26 which is used to transmit valuation requests and responses between the apparatus of this invention and the automated valuation models. Four example automated valuation models are depicted in this figure: AVM W 36, AVM X 38, AVM Y 40 and AVM Z 42. There may be fewer or more automated valuation models included in practice, though for purposes of the detailed description of this invention only four are included. The automated valuation model valuations and requests for valuation will be sent using the automated valuation model connector.

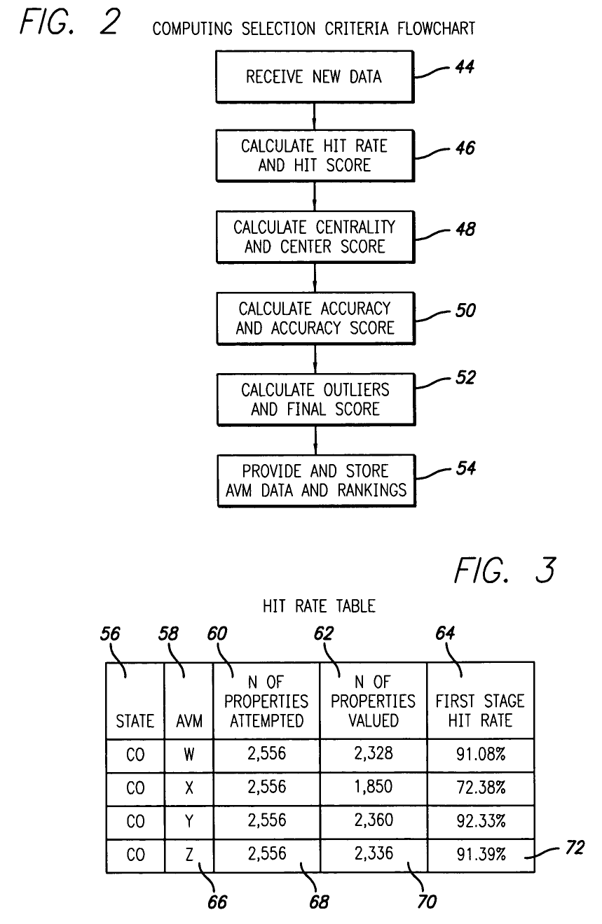

Referring next to FIG. 2, a flowchart of the steps included in the preferred embodiment of the invention is depicted. The steps depicted here may be altered in order, some removed or some added. This is, however, the preferred embodiment of the invention. The first step is to receive new data 44. This data will generally pertain to which automated valuation models to rank and relevant new-sales or appraisals of properties. The new sales and appraisals data is used in order to provide the rankings. New sales price data of recently sold “comparable properties” or “comps” are the most relevant indicator of “true value” for a particular subject property. So, for example, in order to provide useful hit rate, centrality, accuracy scores or outlier scores; recent and accurate sale-price data must be provided to the method of this invention prior to updates of each automated valuation model to be tested. If any automated valuation model receives this data, prior to testing, the automated valuation model will be good at valuing recently sold properties. New sale data will typically be updated and automated valuation model valuations will be requested immediately. These valuations and sales prices will be stored for later use in aggregate to rank the automated valuation models and to calculate some or all relevant indicators using the method of this invention. Once some new data (usually sales data) is received, testing may begin.

The ranking process occurs in a series of steps. At each step, more points are removed for each additional deficiency. In cases where a “state of the art” is used and in the unusual event that an automated valuation model is more accurate than the state of the art, points may actually be added. However, this is not the typical case. As points are taken away, the overall score decreases. The scores are then evaluated relative to each other in a given geographic area, price tier or other subset of properties. The automated valuation model with the highest remaining score or “points” will receive the highest ranking. In alternative embodiments, points may be added to scores relative to the accuracy of a given AVM or group of AVMs. Division or multiplication may also be used, such as by percentages in the preferred embodiment of this invention, to accomplish the same general goal of adding to or taking away a certain number of points based upon the value of the individual indicators calculated at each step.

In the preferred embodiment of the invention, each automated valuation model begins the ranking process with one thousand (1000) points. As the ranking process progresses through the iterative steps, more and more points are taken away through multiplication in the preferred embodiment; in alternative embodiments by subtraction or by some other method. At the end, the automated valuation model with the largest number of points remaining is the “best” automated valuation model in the geographic region, price tier or other subset of all properties. Contrary to the methods of the prior art, instead of considering “perfect” to be the standard by which automated valuation models are ranked, in some cases a “state of the art” is defined in the preferred embodiment of the invention. In the preferred embodiment, this state of the art is used in two of the steps of the preferred embodiment of the invention to rank automated valuation models. This value may change as AVMs improve or as valuations become more difficult. The state of the art may also simply not be used in alternative embodiments of the invention.

Referring now to FIG. 2, the first step in ranking the automated valuation models using the preferred embodiment of the invention and after the receipt of new data, is to calculate a hit rate and hit score 44 for each automated valuation model valuation to be tested. The hit rate is a measure of the percentage of properties for which the automated valuation model can provide valuations. The hit rate used in the preferred embodiment of the invention is a “useful hit rate” which is a more accurate measure of hit rate than the traditional hit rate that is well-known in the prior art. Lower useful hit rates will result in more points being taken away from the overall score of the automated valuation model. The next step is to calculate centrality and a center score 48. This is a measure of the extent to which the automated valuation model valuations are “centered” around the true values of the properties being tested. The next step is to calculate accuracy.

Accuracy is a measure of the extent to which the valuations made by the automated valuation model being tested are spread out around the true values of the properties being tested. Typical measures used for this purpose, median absolute variance or square root of mean squared error, are used. Next, the percentages of outlier variances are calculated and a final score is calculated 52. In this step, the percentages of outliers result in the assignment of penalties based upon the size of the percentages, in the preferred embodiment, penalties are amplified more for being further away from the true value and for overvaluation of the property. Finally, the AVM data and rankings are provided and scored 54. The specific order of the steps and the use of several slightly different elements will be described in detail. Once the invention is described more fully, the benefits of the order of these steps and the alterations of several measures from the preferred embodiment will more fully be described.

In FIG. 3, a hit rate table is depicted for Colorado. This can be seen in element 56, where the state is shown to be CO. Also depicted is the automated valuation model being tested in the column depicted in element 58. The data depicted is from real automated valuation models. The names given are AVMs W, X, Y and Z. Z is depicted in element 66. The number of properties is depicted in element 60, for example for AVM Z, the number of properties for which an automated valuation was attempted was 2,556, as depicted in element 68. The number of properties for which valuations were provided was 2,336 as shown in element 70. The number 2,336 divided by 2,556 is 0.9139 or 91.39% as depicted in element 72. This is described herein as the “first stage” hit rate in element 64. This is called the first stage hit rate because further refinement to the hit rate calculation is useful and is completed in the preferred embodiment of the invention. However in alternative embodiments, this number, as calculated, may be the hit rate used for ranking automated valuation models.

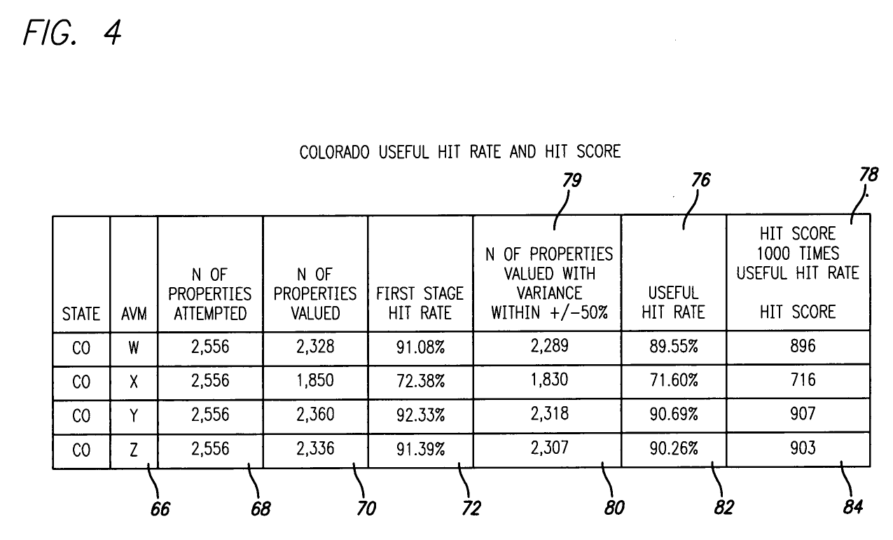

The next portion of this step, in the preferred embodiment, is to calculate the “useful hit rate.” This calculation is depicted in FIG. 4. This is the hit rate used in the preferred embodiment of the invention. This useful hit rate is used because it has been demonstrated that “hits” with variances of more than 50% from the true value of the property are more typically are due to data errors in the automated valuation model database than to poor automated valuation model performance or design.

In the AVM industry, “variance” represents the percentage deviation made by an AVM in valuing a property relative to its true value, typically as measured by sale price. For example, if a property sells for $500,000 but the AVM valued it at $550,000, the variance is ($550,000−$500,000)/$500,000=0.10 or 10%. If the AVM had valued this property at only $450,000 it would commit a variance of −10%. Therefore, under the preferred embodiment of the invention, “hits” that provide valuations of less than 50% times the true value or more than 150% times the true value are not considered “hits” for purposes of ranking automated valuation models. This percentage may be altered to any percentage. Reasonable alternatives range from 40% to 80%, though larger or smaller percentages may be used.

The useful hit rate is used as the first step in calculating the accuracy and ranking of an automated valuation model because it is a baseline of the usefulness of a particular automated valuation model. If no “hit” for a property is available, then that automated valuation model is not useful at all for that property because the AVM is either unable to find and value the property or it values the property only with great inaccuracy; on a set of valuations with few hits, the AVM's effectiveness is greatly reduced. The automated valuation model must return some value for the vast majority of properties to even be in the running for being the best automated valuation model. Here, a “state of the art” hit rate is not used in the preferred embodiment because appraisals or other valuation models may be added to the method of the invention. An appraisal would have a “hit rate” of 100% and some automated valuation models may reach hit rate percentages in the high nineties. Therefore, at this stage the “state of the art” hit rate is not used. In alternative embodiments of the invention, a state of the art hit rate may be used rather than the assumed 100% or perfect potential for hits.

So, for AVM Z, depicted in element 66 of FIG. 4, the number of properties for which valuations were requested is 2,556, depicted in element 68. The number of properties for which values was returned is 2,336 in element 70 and therefore the first stage hit rate is 91.39% as depicted in element 72. The next step is to remove properties for which the valuation was more than plus or minus 50% away from the true value of the property. When this is done, twenty-nine properties are removed and this results in 2,307 properties, depicted in element 80, with valuations within plus or minus 50%, depicted in element 74, of the true value. The useful hit rate 76 is shown in element 82 to be 90.26%. This is calculated, similarly to above, by dividing 2,307 from element 80 by 2,556 from element 68. To calculate the hit score 78, the useful hit rate of 90.26% is multiplied by 1000 to reach a rounded value of 903 as the hit score, depicted in element 84.

As is shown in FIG. 2, the next step is to calculate the centrality and the center score 48. Centrality is the extent to which a particular automated valuation model's valuations (the distribution of the variances it makes) are centered around the true values of the properties. Consistent overvaluation in particular, demonstrated by a positive mean or median variance, may be dangerous for a lender. Overvaluation may cause a lender to over-lend on a particular property or a set of properties leaving them open to significant losses should the property owner(s) default on the loan. Therefore, in the preferred embodiment of the invention, overvaluation is penalized to a greater extent than is undervaluation. Centrality is used as the second indicator for automated valuation model accuracy because it demonstrates the overall tendency of an automated valuation model to either under or over value a property. Centrality, as its name demonstrates, determines where the center of valuations is in relation to the true value of the group of properties.

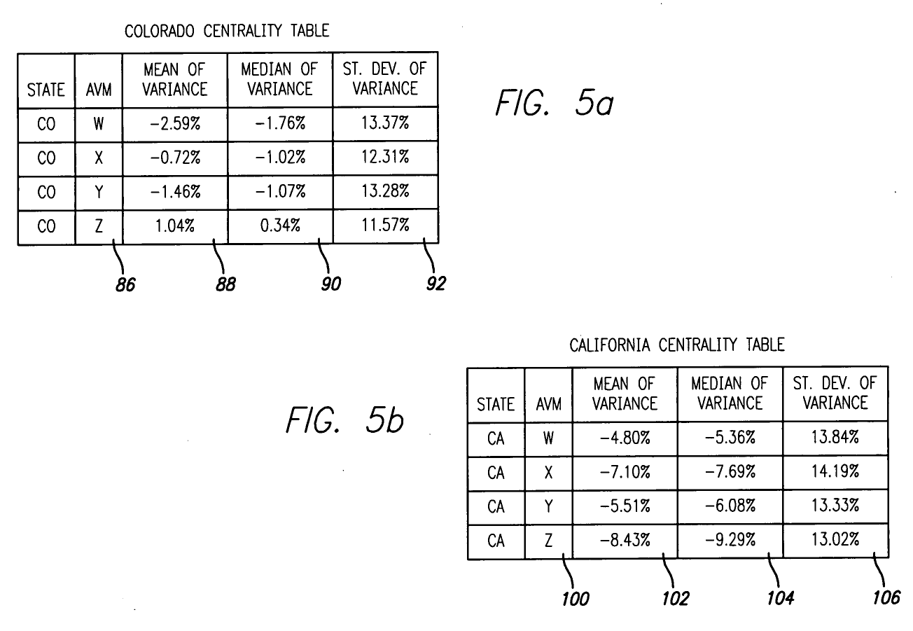

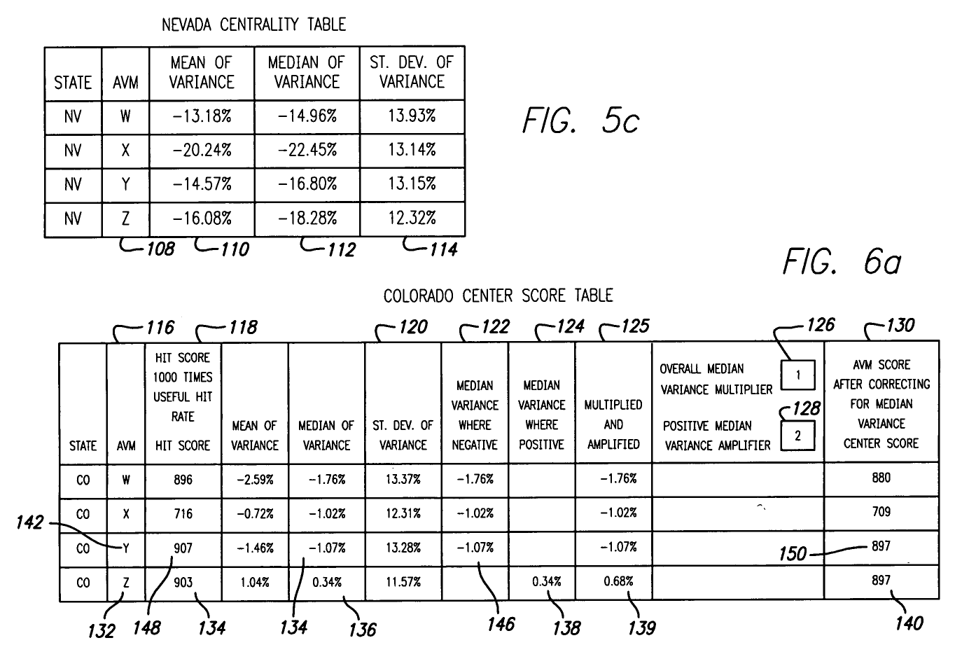

The centrality calculation of the preferred embodiment is demonstrated in FIGS. 5a-5c. The first step in centrality calculations is depicted for Colorado in FIG. 5a. The mean of variance 94, the median of variance 96 and the standard deviation of variance 98 are depicted. For example, for AVM Z 86 in Colorado, the mean of variance is 1.04%, depicted in element 88, the median of variance is 0.34%, depicted in element 90 and the standard deviation of variance is 11.57%, depicted in element 92.

The median of variance is the best indicator of centrality. The variance is the error in valuation by the AVM with respect to the sale price, as described above. The median variance is the “middle” of all of the variances for the valuations with respect to the corresponding sale prices. It is better than the mean variance because a mean variance may be “skewed” to one side by a “long tail.” Therefore, the “center” value or median of the variances is the best indicator to be used for centrality. For AVM Z, depicted in element 86, in Colorado, the median of variance of 0.34% in element 90 is very close to zero, indicating that the AVM on the whole gives a distribution of variances balanced around the true value. Therefore, for AVM Z in element 86, the centrality is very good.

Similar centrality tables for purposes of example are depicted in FIGS. 5b and 5c for California and Nevada respectively. In FIG. 5b, AVM Z 100 has a mean of variance of −8.43% in element 102, a median of variance of −9.29% in element 104 and a standard deviation of variance of 13.02% in element 106. For Nevada, depicted in FIG. 5c, AVM Z 108 has a mean of variance of −16.08% in element 110. AVM Z 108 also has a median of variance of −18.28% in element 112 and a standard deviation of variance of 12.32% in element 114. AVM Z, element 100 in California, and AVM Z, element 108 in Nevada, performed more poorly in these states than in Colorado, the median of variance being −9.29% and −18.28% in elements 104 and 112 respectively. These values are significantly worse than their counterpart in element 90, but relative to some other medians of variance, are still fairly good. Because one of the objectives of the present invention is to rank, all ranking is done in comparison to other automated valuation models (or in alternative embodiments appraisals).

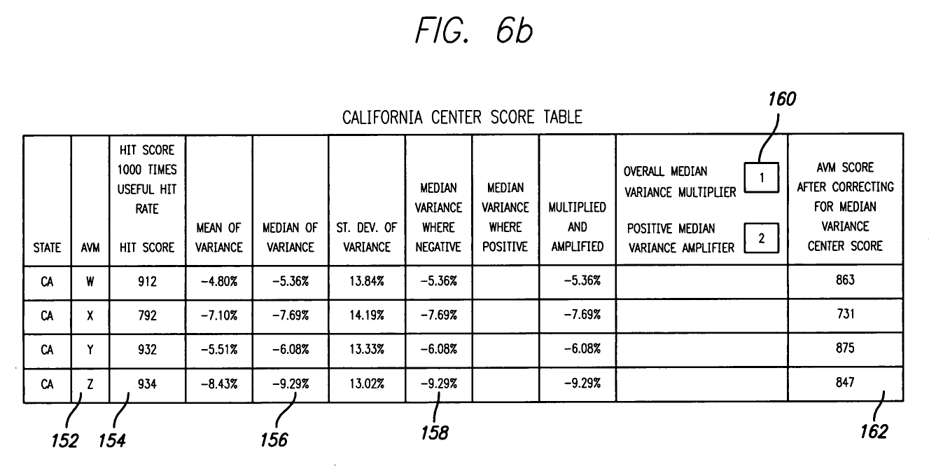

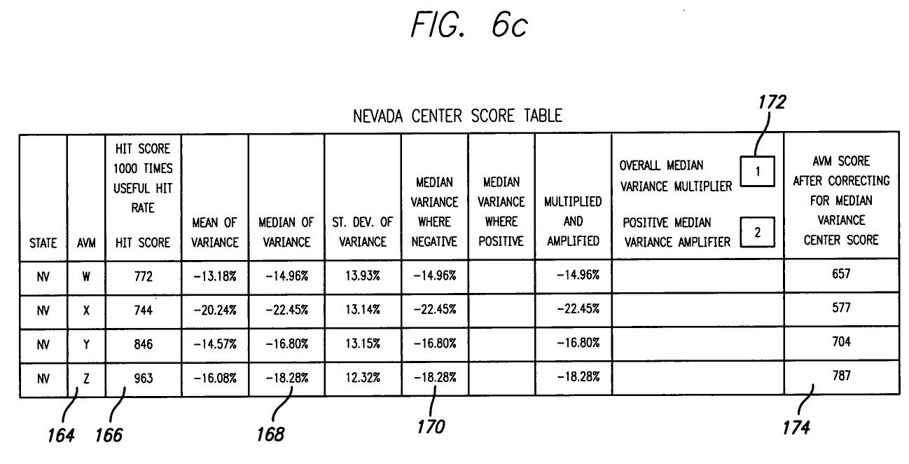

Referring next to FIG. 6a, the calculation of the center score is depicted. Element 116 is the AVM being used. Element 118 is the hit score, as it appeared in FIG. 4. The median of variance from FIG. 5a is depicted in element 120. There are three new columns in this diagram, median variance where negative 122, median variance where positive 124 and median variance multiplied and amplified 125. These columns are used, to separate negative variances from positive variances so that the positive variances may be “amplified.” Because positive variances are especially bad for the lender, they are penalized or “amplified” more than negative variances. Also depicted is the overall median variance multiplier 126, which in this example is 1. This could be made larger or smaller, in alternative embodiments, if centrality was more or less important to the particular user of this method and apparatus. The positive median variance amplifier 128 is also depicted and in this example is 2. This could also be made larger or smaller depending upon the importance of centrality, and the importance of especially penalizing over-valuations, to the user of this method and apparatus. Finally, the column for center score 130 is depicted.

AVM Z, depicted in element 132, has a median variance of 0.34%, depicted in element 136. This number is then shown in the median variance where positive 124 column as 0.34% in element 138. This value is then multiplied by the positive median variance amplifier of 2, depicted in element 128 to arrive at the number 0.68%, as depicted in element 139. Then, the hit score is multiplied by 100%−0.68% or 99.32% to arrive at the final center score which is rounded off to 897, depicted in element 140. AVM Y, depicted in element 142, has a median variance that is −1.07%. This value is then depicted in the median variance where negative 122 column in element 146. It is then multiplied by the overall median variance multiplier of 1, depicted in element 126. This number is then made an absolute value which results in the value 1.07%. Then, this number is subtracted from 100% to result in 98.93% which is then multiplied by the original hit score of 907, depicted in element 148. This multiplication results in the center score 130 of 897, depicted in element 150. At this point in the ranking calculation of the preferred embodiment, AVM Y has the same score as AVM Z.

The center score is also not used with a “state of the art” because ideally, every automated valuation model is capable of being centered on the true value. This is one of the goals every automated valuation model strives for and though each automated valuation model will not be able to be perfect, being close to perfect over a large series of valuations is not at all impossible. As can be seen above, most automated valuations were approximately 1% off in the centering of the distribution of their variances, in certain states, while AVM Z in element 132 was only off by 0.34%, as seen in element 136.

Depicted in FIG. 6b and 6c are similar tables for California and Nevada respectively. In FIG. 6b, for California, AVM Z is depicted in element 152. Its hit score was 934, as depicted in element 154. It has a median of variance of −9.29%, depicted in element 156. This value is a negative variance so it is placed in the median variance where negative column as depicted in element 158. This is then multiplied by the same overall median variance multiplier 160 of 1 in this example. As above this number may be lager or smaller depending upon the importance of centrality to the user. This results in a value of −9.29%. The absolute value of this number is then subtracted from 100%. This results in a value of 90.71%. The hit score 154 of 934 is then multiplied by this percentage. This results in the center score for AVM Z in element 152 of 847, as depicted in element 162.

Referring now to FIG. 6c, a similar center score calculation table is depicted for Nevada. AVM Z in element 164 has a hit score in Nevada of 963, as shown in element 166. The median of variance for AVM Z in element 164 is −18.28%, as shown in element 168, and therefore the median variance where negative is −18.28%, as shown in element 170. Because the median variance is negative, it is multiplied by the overall median variance multiplier of 1, depicted in element 172. This multiplier could be larger or smaller depending upon the needs of the user of this method. The absolute value of this number is taken and 100% is subtracted from it which results in a value of 100%−18.28% or 81.72%. This is multiplied by the hit score of 963, depicted in element 166, which results in a center score of 787, depicted in element 174. This score represents the cumulative combination of the hit score and center score.

As depicted in FIG. 2, the next step of the preferred embodiment is to calculate the accuracy and accuracy score, as shown in element 50. The accuracy indicators of the preferred embodiment are median absolute variance and square root of mean squared error. The median absolute variance is an indicator of the approximate “center” of the size of the errors. This value demonstrates what the middle error size is for a particular automated valuation model. It is an indicator of accuracy because it demonstrates the extent to which an automated valuation model is more or less accurate. The smaller this number, the closer to the true value the automated valuation model valuations tend to be. The other indicator of accuracy is the square root of mean squared error. This value is an indicator of the standard deviation of an automated valuation model's valuation's errors, measured around the zero point rather than around the mean of the distribution of variances. Basically, it says how tightly clustered the estimates of value are around the true value of their particular property, for a given set of properties. The smaller this number is, the larger the number of valuations are within a smaller range around the true value of a property, and the closer or tighter is that range around the true values. With smaller numbers, the spread of the distribution of variances (errors) made by the AVM is tighter and narrower.

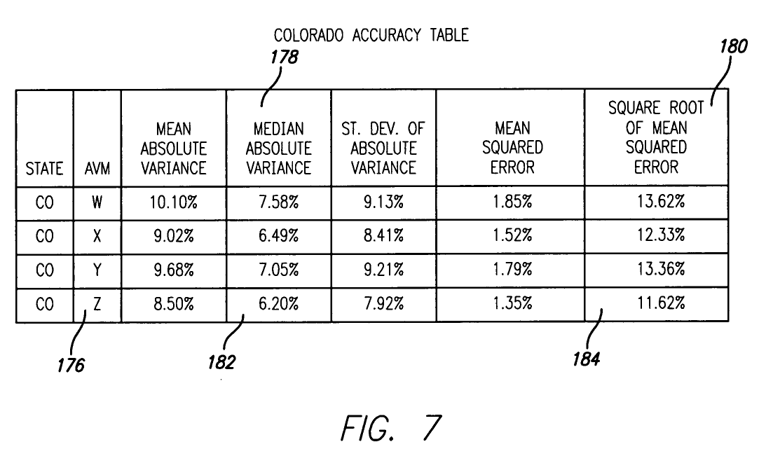

A preliminary table for calculating an accuracy score is shown in FIG. 7. Various indicators are calculated, such as the median absolute variance 178 and the square root of mean squared error 180. For AVM Z, depicted in element 176, the median absolute variance is 6.20%, depicted in element 182, and the square root of mean squared error is 11.62%, depicted in element 184. The median absolute variance is the middle of the “size of error.” It is an indicator of the extent to which the particular AVM is accurate or inaccurate. In the case of AVM Z 176, the AVM's median absolute variance is 6.20% (referring to the median size of the variance, without regard to a direction of positive or negative). Half of the errors made by AVM Z on this data set are less than 6.20% in size (positive or negative) and half are larger or greater in size. The square root of mean squared error 180 is essentially a standard deviation of errors, measured around the zero point. The square root of mean squared error 180 for AVM Z in element 176 is 11.62%, as seen in element 184. That is, approximately 68% of values given by AVM Z in element 176 will fall within 11.62% of the true value if the distribution of errors were a classical normal bell-shaped distribution.

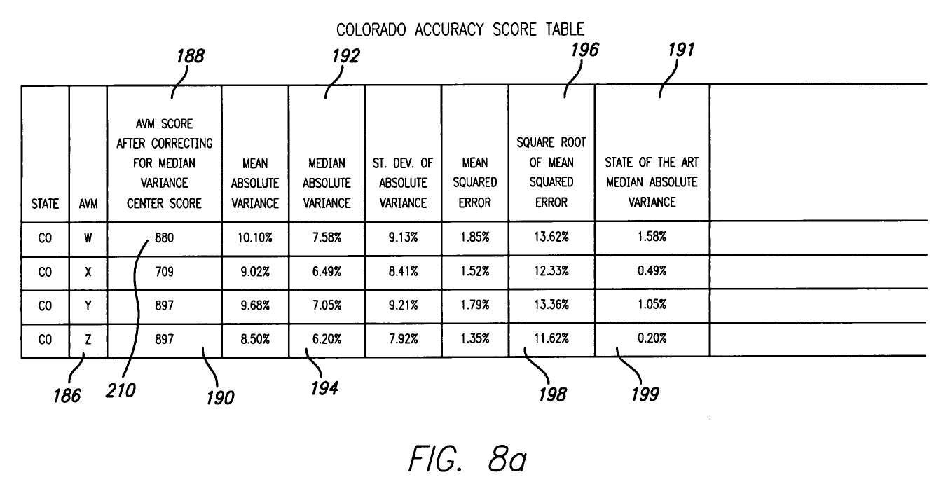

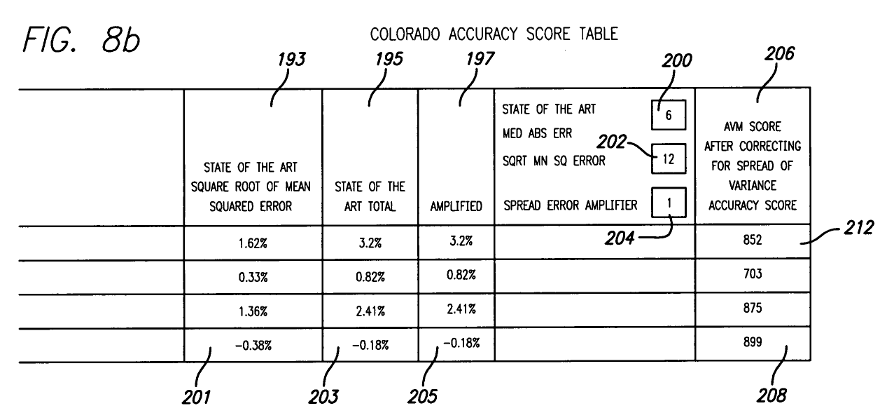

Referring together now to the single table represented by FIGS. 8a and 8b, the calculation of an accuracy score, using the data depicted in FIG. 7 can be seen. The center score, from FIG. 6a is shown in the column in element 188, the center score for AVM Z in element 186 is shown in element 190 as being 897. The median absolute variance column 192 shows that AVM Z in element 186 has a median absolute variance of 6.20% as shown in element 194. It also has a square root of mean squared error 196 of 11.62%, as shown in element 198.

For the calculation of an accuracy score, a “state of the art” factor is applied. The state of the art is the value which the “best” automated valuation models or appraisals are able to determine. For example, in the preferred embodiment, the state of the art median absolute error is declared to be 6 (representing 6%) as depicted in element 200. Similarly, the state of the art square root of mean squared error is 12 (representing 12%), as shown in element 202, in the preferred embodiment. Finally, the spread error amplifier is 1, as shown in element 204. This spread error amplifier is the extent to which errors of accuracy will be penalized, multiplicatively. If the amplifier is set to two, for example, then for each percent greater than the “state of the art” the AVM score is penalized twice the percentage it would if the amplifier is set to one, as in the preferred embodiment.

To perform this calculation, the state of the art median absolute variance is subtracted from the AVM's mean absolute variance. A “state of the art” approach is used because it has been found that AVMs (and appraisals) cannot be expected to attain a spread of zero width (perfect accuracy for all valuations, not just a correct centering), and should not be judged with such perfection as a baseline. Instead, inspection of the performances of the more accurate AVMs in different states and other regions has suggested the use of 6% as a “state of the art” baseline which would represent a good performance for an AVM's median absolute error. This state of the art may be varied depending upon the subset of properties for which the AVMs are being ranked.

In this case the state of the art median absolute error is 6%, as is seen in element 200, is subtracted from the median absolute variance of 6.20%, as shown in element 194. The column representing the difference between the median absolute variance and the state of the art is depicted in element 191. The subtraction of the state of the art median absolute variance from the median absolute variance of AMV Z results in a 0.20% variance from the state of the art, as depicted in element 199. Also, the state of the art square root of mean squared error, which is 12%, as seen in element 202, is subtracted from the square root of mean squared error, in this case 11.62%, as seen in element 198. This results in a difference between the square root of mean squared error and the state of the art, as shown in element 193, of −0.38%, as depicted in element 201. These two values are then added together, to calculate the state of the art total 195, which results in a value of −0.18%, as seen in element 203. This value is then multiplied by the spread error amplifier, in the preferred embodiment 1, but which may be different numbers in different embodiments of the invention, and results in an amplified total 197 of −0.18%, as seen in element 205. This value is then subtracted from 100%, such as 100% minus −0.18%. In this case, the formula becomes 100%+0.18%. This number, 100.18% is then multiplied by the original center score, show in element 190 as 897, to reach a value of 899, as shown in element 208.

In this example, the accuracy score actually improved, due to the automated valuation model valuations for this particular AVM being slightly more accurate than the “state of the art.” In most cases, as can be seen in FIGS. 8a and 8b, the state of the art is not surpassed. Therefore, the accuracy scores in column 206 are typically less than the center scores depicted in column 188. So, for example, in element 210, the center score of AVM W is depicted as 880. Once all calculations are completed, the accuracy score, shown in element 212, is 852. This demonstrates somewhat of a departure from the state of the art; that AVM W's performance was somewhat lower than the state of the art. The accuracy score now reflects that this automated valuation model is ranked lower, so far, overall, than AVM Z, with a accuracy score of 899, shown in element 208.

Referring again to FIG. 2, the next step is to calculate the percentages of outlier variances (large positive and negative errors, made outside certain limits) and the final score, as shown in element 52. Outliers are valuation variances that are very large, very far away from the true value of the property. These values are detrimental to a lender making loans on a property based upon an automated valuation especially when the outliers are strongly positive because this can lead to over-lending. If over-lending occurs and the property goes into default, the lender can be left with a significantly overvalued property and no way to recover the money lent on the property. Therefore, in the preferred embodiment of this invention, positive outlier variances are significantly penalized in comparison to their negative counterparts. This is done to represent the potentially significant problem lenders have with a substantially overvalued property.

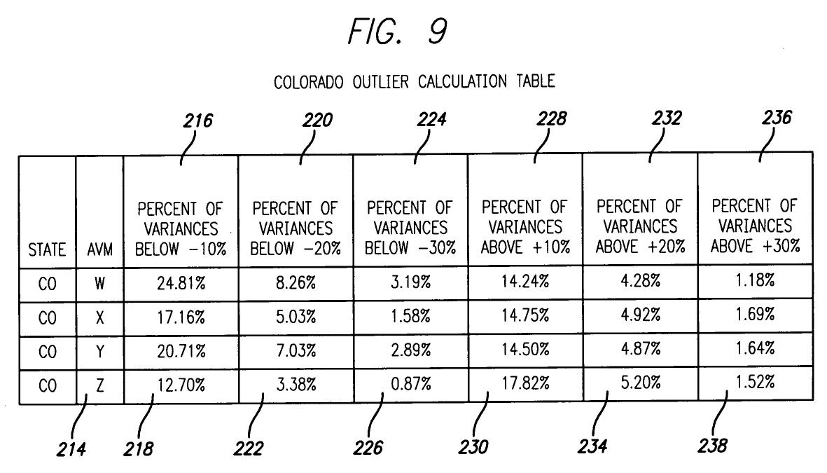

Referring now to FIG. 9, the initial calculations to be used in calculating the final score are depicted. Four AVMs are again depicted, with AVM Z in element 214 being one. There are six columns, though this number may be varied in alternative embodiments to be any number more than zero. For example, only positive variances over 20% could be used, but in the preferred embodiment, tiers of variances are used and these tiers are both above and below the true value. The percent of variances below −10% is depicted in element 216. This column is the percent of AVM valuations that were more than 10% below the true value of the property. Element 220 is the percent of variances below −20% and element 224 is the percent of variances below −30%. Similarly, these are the percent of properties overall that were undervalued by the AVM by more than 20% and 30%. Similarly, columns on the right depict the percent of variances above +10% in element 228, percent of variances above +20% in element 232 and percent of variances above +30% in element 236.

In each of these columns, AVM Z in element 214 is depicted in the bottom row. For example, the percent of variances below −10% for AVM Z is 12.70%, depicted in element 218. The percent of variances below −20% is 3.38%, depicted in element 222. Finally, the percent of variances below −30% is 0.87%, depicted in element 226. As one would expect, the percentages drop substantially as one moves further away from the true value. On the positive side, the values also drop. The percent of variances above +10% is 17.82%, depicted in element 230, while the percent of variances above +20% is only 5.20%, depicted in element 234. Finally, the percent of variances above +30% is only 1.52%, depicted in element 238. As can be seen, AVM Z 214 appears to be overvaluing properties more often than it undervalues them. Its positive outlier variance percentages are larger than the corresponding negative outlier percentages.

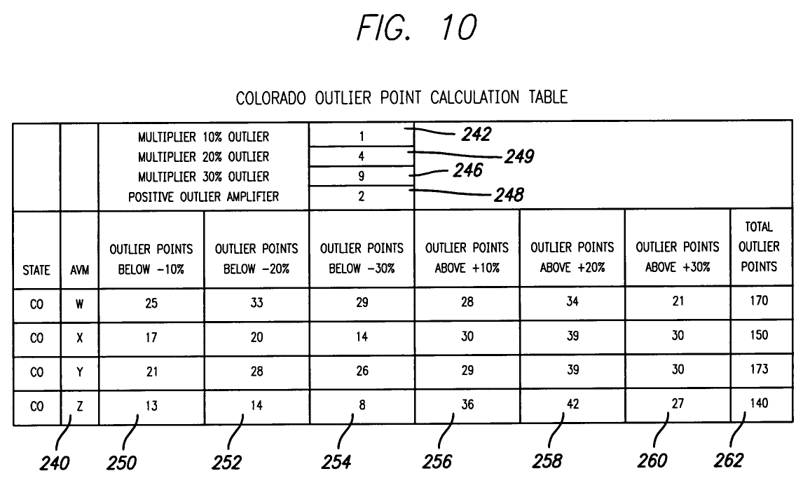

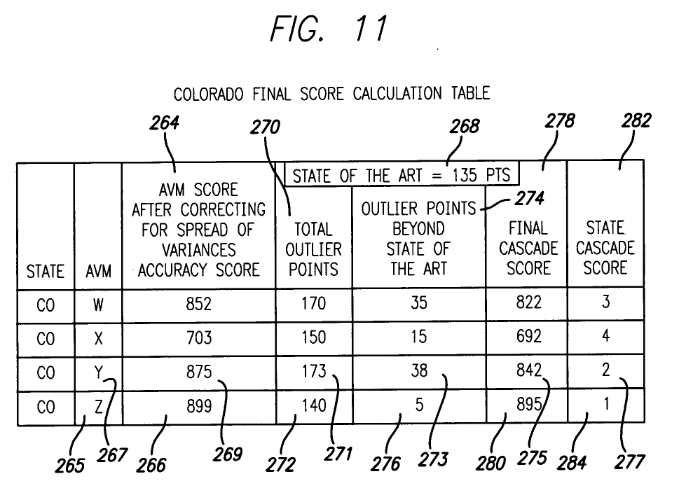

The next portion of this step is depicted in FIG. 10. In this Figure, the values from FIG. 9 are multiplied by their respective multiplier and then rounded to the nearest integer. In alternative embodiments, the numbers may be used in decimal or percentage form up to any number of significant digits. For example, again, AVM Z is depicted in element 240. Also depicted are the various multiplicative factors (or amplifiers) for outliers of specific ranges of sizes. So for example, an outlier that is plus or minus 10% will only be multiplied by 1 in the preferred embodiment, thus not receiving any amplification of the punitive effect. This can be seen in element 242, the multiplier 10% outlier. This multiplier outlier is further amplified by the positive outlier amplifier of 2, depicted in element 248. This means that values that are positive outliers will have their negative impact on the overall score amplified by a factor of two. This number may be changed or even eliminated in alternative embodiments. However, this number exists for the reason that positive outliers, especially significantly positive outliers, signify properties for which the lender may substantially over-lend. Outliers of plus or minus 20% will receive an amplification of four in the preferred embodiment, to especially penalize large valuation errors. This “four” is in turn multiplied for positive outlier variance percentage by the factor of two, similarly to the 10% outliers.

Finally, all outliers greater than plus or minus 30% will receive an amplification of nine times their original value. This can be seen in element 246, the multiplier 30% outlier. If the outlier is a positive value greater than 30%, it will be again amplified by two times, as can be seen in element 248, the positive outlier amplifier. This, again, reflects the detrimental impact largely overvaluing properties will have upon the vast majority of automated valuation model and appraisal users.

Each of these amplifiers and multipliers are somewhat arbitrary. Generally, in the preferred embodiment, larger outliers should be penalized more than smaller outliers and positive outliers should also be penalized more than negative outliers. However, in alternative embodiments, the outliers on either side may be penalized equally. Alternatively, only outliers of a certain degree may be considered. The percentage values which are considered outliers may also be changed in alternative embodiments and the positive outlier amplifier, depicted in element 248 may be changed or altogether eliminated in alternative embodiments.

So, for negative outliers below −10%, no positive outlier amplifier is used and the multiplier 10% outlier is only 1, as seen in element 242, therefore, the value, for AVM Z is 13, as depicted in element 250. This is the result of the original percentage value in element 218 of 12.70% being multiplied by the multiplier 10% outlier of 1, depicted in element 242, then being rounded to the nearest integer of percents. Next, the value of 3.38%, shown in element 222 of FIG. 9 is multiplied by the multiplier 20% outlier of 4, depicted in element 244, and then rounded to the nearest integer of percents. This results in a value of 14, as seen in element 252. Finally, to calculate outlier points below −30%, the percent of variances below −30% of 0.87% as seen in element 226 of FIG. 9 is multiplied by the multiplier 30% outlier of 9, as seen in element 246, in the preferred embodiment. This value is then rounded to the nearest integer of percents, which results in a value of 8, as seen in element 254.

Next, for outlier values 10, 20 and 30 percent above the true value, the positive outlier amplifier of 2 in the preferred embodiment is applied. So, to calculate the outlier points above +10% of 36, depicted in element 256, the percent variances above +10% from element 230 in FIG. 9 are used. This value is 17.82%. It is converted to a number, then multiplied by the multiplier 10% outlier, which is in this case 1, as seen in element 242. Next, it is multiplied by the positive outlier amplifier of 2, as shown in element 248. This results in a value of 35,64, This value is then rounded to the nearest integer number of percents, which results in the value of 36, as shown in element 256.

Next, the outlier points above +20% are calculated. For example, again, the percentage value of 5.20% in element 234 of FIG. 9 is multiplied by the multiplier for 20% outliers of 4, depicted in element 244. This results in a value of 20.8 when converted to a number of percents (multiplied by 100 to do this). This number is then further multiplied by the positive outlier amplifier of 2 in the preferred embodiment, depicted in element 248. This results in a value of 41.6, which is then rounded to the nearest integer number of percentage points to the value 42, as depicted element 258. Finally, the outlier points above +30% are calculated. To do so, the percent of variances above +30% is taken, as a number and multiplied by the multiplier 30% outlier of 9 in the preferred embodiment, as seen in element 246. The percent of variances above +30% is 1.52, as seen in element 238 of FIG. 9. This value, when multiplied by the multiplier 30% outlier of 9 is 13.68. This value is then multiplied by the positive outlier amplifier of 2, to reach a value of 27.36. This value is then rounded to the nearest integer which results in the outlier points above +30% of 27, as shown in element 260. Finally, all of the outlier points for each category are added together which, for AMV Z, results in total outlier points of 140, as seen in element 262.

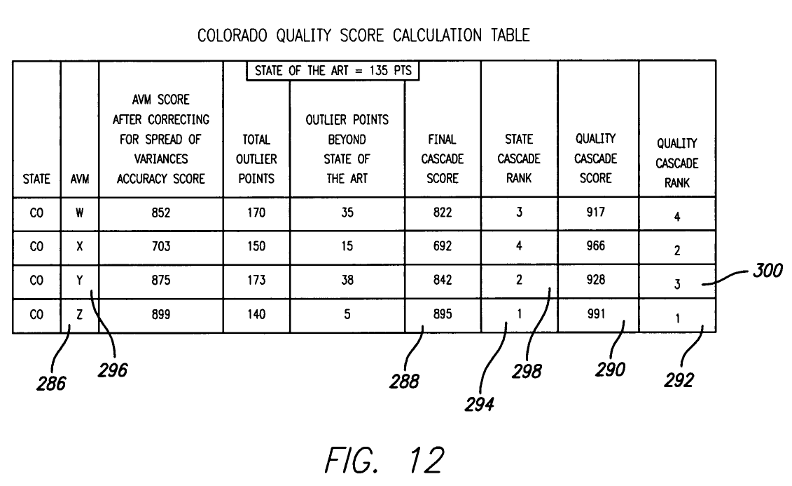

Referring now to FIG. 11, the final computation of score and rank is depicted. First, the AVM accuracy scores, from FIG. 8 are depicted in the accuracy score column 264. Then, the total outlier points in the column of element 270, as calculated in FIG. 10 are depicted. Next, again a “state of the art” factor is applied in element 268. This state of the art of 135, as is seen in element 268 is representative of what the “best” automated valuation models are able to do, since it is not expected that even a good AVM will be able to completely avoid making outlier variances. In alternative embodiments, this value may be different and may improve as the art improves. Alternatively, a “state of the art” may not be used in other embodiments. The state of the art is subtracted from the total outlier points in the column denoted by element 270 to arrive at the outlier points beyond the state of the art in element 274. This number is then used through a multiplicative or subtractive process applied to the accuracy score, shown in column 264 to result in the final cascade score, depicted in column 278. The highest of the numbers in this column is the best automated valuation model and is afforded the rank 1 in the state cascade rank column 282. The next highest is given rank 2 and so on until the last automated valuation model is ranked.

So, for example for AVM Z in element 265, again, the accuracy score was 899, depicted in element 266. The total outlier points, depicted in element 272 and also in element 262 of FIG. 10, are 140. The state of the art, depicted in element 268 is 135. Therefore, the difference between these two is 5, as shown in element 276. Therefore, the outlier points beyond the state of the art of 5, depicted in element 276, are divided by 1000 and subtracted from 100%. This yields a value of 0.995 or 99.5%. This is multiplied by the accuracy score of 899, depicted in element 266. This yields a final cascade score of 895, as shown in element 280. Because this final cascade score is higher than any other automated valuation model's, AVM Z is given rank number 1, as shown in element 284. Were we to compute the outlier effects first, starting from 1000, we could arrive at a separate “outlier score.”

In order to depict an example of a larger variance from the state of the art, AVM Y in element 267 is also depicted. This AVM has an AVM Score after correcting for spread of variances of accuracy score of 875, as shown in element 269. It also has total outlier points of 173, as shown in element 271. To find the outlier points beyond the state of the art, the state of the art of 135 is subtracted from the total outlier points for AVM Y, which results in a value of 38, as depicted in element 273. The accuracy score of 875, depicted in element 269, is multiplied by (1−38/1000); that is, it is multiplied by 0.962 or 96.2%, producing 841.75 which has been rounded to 842 as shown in element 275. This results in a final cascade score of 842, depicted in element 275. Therefore, AVM Y, with a final cascade score of 842, is second, and is thus given a rank of number 2, as can be seen in element 277. This change from the AVM Score shown in the column indicated by element 264 is much larger than the variance of that for AVM Z. This means that for AVM Y, there was a more significant impact of outlier points on the overall precision of the automated valuation model. This is reflected in that the total outlier points beyond the state of the art is significantly larger. The outlier points beyond the state of the art for AVM Y are 38, depicted in element 273, compared to 5, depicted in element 276, for AMV Z. Therefore, AVM Y's final score and rank are affected more in this stage of the ranking process, than AVM Z's.

The final score is the result of a cumulative and multiplicative, especially in the last step, calculation. The calculation makes sense and more penalty is incurred for valuations that are significantly off from the true values, especially significant overvaluation. The order of the steps as performed in the method of this invention is logical and purposeful, moving from the ability to provide a valuation at all, to the centrality of the valuations in relation to the true value. Next, the evaluation moves to the range of valuations around the true value (looking at the width of that range, representing the size of the errors in valuation made by the AVM) and finally to a substantial penalty for large over and under-valuations. However, in alternative embodiments of the invention, steps may be added, removed or the order of steps may be changed. The penalties incurred for particular errors may be increased or decreased from the penalties of the preferred embodiment.

It will be apparent that automated valuation models may be ranked using alternative scores which utilize fewer, more or an alternative ordering of steps or factors. Although the preferred embodiment uses multiplication by a percentage value less than 100% to reduce the scores, many other methods may be employed without varying from the overall scope of the present invention. Alternative embodiments may also utilize steps or factors in addition to one or more of the four listed herein. It will also be apparent that instead of multiplying the current score by the percentage reduction, a number could simply be subtracted from the current score. Alternatively, the current score could be reduced using division or the addition of a negative number of percent.

For example one alternative embodiment is described in FIG. 12, wherein a quality score calculation table for the state of Colorado is depicted. The quality score only considers an automated valuation model's accuracy, centrality and outlier percentages. It does not take into account the hit rate or useful hit rate. FIG. 12 is substantially the same as FIG. 11, with the addition of the two right-hand columns. The two right-hand columns depict the quality cascade score for the automated valuation model, without the removal of any points due to some non-hits. The final column is the new ranking, given the removal of this portion of the calculation. In this embodiment, the useful hit rate step would simply be skipped. However, for purposes of demonstration, this score was calculated by a simpler and similar method. The final cascade score obtained by the full four-step process was multiplied by 1000 and divided by the hit score, to create the quality cascade score, a mathematically equivalent process.

So, for AVM Z, depicted in element 286, the final cascade score is 895, as depicted in element 288. In FIG. 4, the hit score was 903, as shown in element 84. So, 895 * 1000/903=991. Therefore, the quality cascade score is 991, as shown in element 290. This is the highest quality cascade score, therefore AVM Z remains the highest ranked automated valuation model. However, AVM Y, depicted in element 296 has an original rank of 2, as shown in element 298, but when the quality cascade ranking is done, the ranking becomes a 3, as shown in element 300. This means that AVM Y had a better hit rate than AVM X, but because that factor is not being considered any longer, then AVM X is now better, using these ranking criteria.

It will be apparent to those skilled in the art that the present invention may be practiced without these specifically enumerated details and that the preferred embodiment can be modified so as to provide additional or alternative capabilities. The foregoing description is for illustrative purposes only, and that various changes and modifications can be made to the present invention without departing from the overall spirit and scope of the present invention.

What is claimed is:

1. A computer-based method of calculating an automated valuation rank, comprising the steps of:
gathering new data on at least one property;
requesting automated valuation model valuations of said at least one property;
calculating an automated valuation model rating based on at least one indicator of precision for said at least one property; and
calculating the automated valuation rank based upon said automated valuation model rating.

2. The method of claim 1, wherein one of said at least one indicator of precision is a hit rate.

3. The method of claim 1, wherein one of said at least one indicator of precision is a useful hit rate.

4. The method of claim 1, wherein one of said at least one indicator of precision is a center score.

5. The method of claim 1, wherein on of said at least one indicator of precision is an accuracy score.

6. The method of claim 1, wherein one of said at least one indicator of precision is an outlier score.

7. The method of claim 1, wherein said calculating step is accomplished using four of said indicators of precision calculated in the following order: useful hit rate calculation, center score calculation, accuracy score calculation, and outlier point calculation which are used to thereby calculate said automated valuation model rating.

8. The method of claim 3, wherein said useful hit rate calculation is a hit rate calculation with valuations with variances larger than a specified percentage removed.

9. The method of claim 5, wherein said accuracy score is calculated using a state of the art score, whereby only an accuracy score greater than said state of the art score will result in penalties to said automated valuation model rating.

10. The method of claim 6, wherein said outlier score is calculated using a state of the art score, whereby only an outlier score greater than said state of the art score will result in penalties to said automated valuation model rating.

11. The method of claim 4, wherein said center score calculation reduces said automated valuation model rating by multiplying by a percentage equal to one hundred percent minus the percentage median of variance from the true value, converted to a positive number by taking its absolute value and then applying a multiplier to reflect the relative importance of overvaluations and undervaluations.

12. The method of claim 5, wherein said accuracy score calculation reduces said automated valuation model rating by multiplying by a percentage equal to one hundred percent minus the result of a spread error amplifier multiplied by the sum of:
a) the automated valuation model median absolute variance percentage, minus the state of the art median absolute variance percentage, and
b) the automated valuation model square root of mean squared error percentage, minus the state of the art square root of mean squared error percentage.

13. The method of claim 12, wherein said state of the art median absolute error is taken as zero.

14. The method of claim 12, wherein said state of the art square root of mean squared error is taken as zero.

15. The method of claim 5 wherein said accuracy score calculation reduces said automated valuation model rating by subtracting the result of a spread error amplifier multiplied by the sum of:
a) the automated valuation model median absolute variance minus the state of the art median absolute variance, and
b) the automated valuation model square root of mean squared error, minus the state of the art square root of mean squared error.

16. The method of claim 6, wherein said outlier score calculation reduces said automated valuation model rating by multiplying the total score by one hundred percent minus a percentage reflecting the sum of all outlier points minus a predetermined state of the art level of outlier points, where the outlier points themselves represent predetermined percentages which points have been individually been multiplied by a multiplier reflecting the size of the outliers in particular groups based on said predetermined percentages, and wherein said outlier points that represent positive outliers are further multiplied by an additional positive outlier amplifier.

17. The method of claim 15, wherein said state of the art median absolute variance is taken as zero.

18. The method of claim 15, wherein said state of the art square root of mean squared error is taken as zero.

19. The method of claim 16, wherein said state of the art level of outlier points is taken as zero.

20. The method of claim 6, wherein said outlier score calculation reduces said automated valuation model rating by subtracting a value representing the sum of all outlier points minus a predetermined state of the art level of outlier points, where the outlier points themselves represent the valuation variance below and above predetermined values, which points have been multiplied by a multiplier based on the size or magnitude of said values, and wherein said outlier points that represent positive outliers are further multiplied by an additional positive outlier amplifier.

21. The method of claim 20, wherein said state of the art level of outlier points is taken as zero.

22. A computer-based method of calculating an automated valuation rank, comprising the steps of:
gathering new data on at least one property;
requesting automated valuation model valuations of said at least one property;
calculating an automated valuation model rating based on two or more of the following indicators of precision:
a) a hit score
b) a useful hit score
c) a centrality score
d) an accuracy score
e) an outlier score
calculating the automated valuation rank based upon said automated valuation model rating.

23. The method of claim 22, wherein said indicators of precision are said useful hit score, said centrality score, said accuracy score and said outlier score.

24. The method of claim 23, wherein said indicators of precision are applied in the order they are listed.

25. The method of claim 23, wherein said indicators of precision are applied without reference to a predetermined order.

26. The method of claim 22, wherein said indicators of precision are said centrality score, said accuracy score and said outlier score.

27. The method of claim 26, wherein said indicators of precision are applied in the order they are listed.

28. The method of claim 26, wherein said indicators of precision are applied without reference to a predetermined order.

29. A computer-based apparatus for calculating an automated valuation rank, comprising:
temporary data storage means for storing relevant data;
input means connected to said temporary data storage means for receiving new data on at least one property;
automated valuation model connection means connected to said temporary data storage means for requesting automated valuation model valuations of said at least one property; and
calculation means connected to said temporary data storage means for calculating an automated valuation model rating based on at least one indicator of precision for said at least one property and further for calculating the automated valuation model rank based upon said automated valuation model rating.

30. The apparatus of claim 29, wherein one of said at least one indicator of precision is a hit rate score.

31. The apparatus of claim 29, wherein one of said at least one indicator of precision is a useful hit rate score.

32. The apparatus of claim 29, wherein one of said at least one indicator of precision is a center score.

33. The apparatus of claim 29, wherein one of said at least one indicator of precision is an accuracy score.

34. The apparatus of claim 29, wherein one of said at least one indicator of precision is an outlier score.

35. The apparatus of claim 29, wherein said calculation means uses four of said indicators of precision calculated in the following order: useful hit rate calculation, center score calculation, accuracy score calculation, and outlier point calculation which are used to thereby calculate an automated valuation model rating and the automated valuation rank.

36. The apparatus of claim 31, wherein said useful hit rate calculation is a hit rate calculation with valuations with variances larger than a specified percentage removed.

37. The apparatus of claim 33, wherein said accuracy score is calculated using a state of the art score, whereby only an accuracy score greater than the state of the art score will result in penalties to said automated valuation model rating.

38. The apparatus of claim 34, wherein said outlier score is calculated using a state of the art score, whereby only an outlier score greater than the state of the art score will result in penalties to said automated valuation model rating.

39. The apparatus of claim 32, wherein said center score calculation reduces said automated valuation model rating by multiplying by a percentage equal to one hundred percent minus the absolute value of the percentage median of variance from the true value, multiplied by a multiplier based on whether that median is positive or negative.

40. The method of claim 33, wherein said accuracy score calculation reduces said automated valuation model rating by multiplying by one hundred percent minus a percentage equal to the result of a spread error amplifier multiplied by the sum of:
a) the automated valuation model median absolute variance percentage minus the state of the art median absolute variance percentage, and
b) the automated valuation model square root of mean squared error percentage, minus the state of the art square root of mean squared error percentage.

41. The method of claim 34, wherein said outlier score calculation reduces said automated valuation model rating by multiplying by one hundred percent minus a percentage representing the sum of all outlier points minus a predetermined state of the art level of outlier points, where the outlier points themselves represent the percentages of valuation variance below and above predetermined percentages, which points have been multiplied by a multiplier based on the size or magnitude of said predetermined percentages, and wherein said outlier points that represent positive outliers are further multiplied by an additional positive outlier amplifier.

42. The method of claim 41, wherein said predetermined state of the art level of outlier points is taken as zero.

43. The method of claim 33 wherein said accuracy score calculation reduces said automated valuation model rating by subtracting the result of a spread error amplifier multiplied by the sum of:
a) the automated valuation model median absolute variance minus the state of the art median absolute variance, and
b) the automated valuation model square root of mean squared error, minus the state of the art square root of mean squared error.

44. The method of claim 34, wherein said outlier score calculation reduces said automated valuation model rating by subtracting a value representing the sum of all outlier points minus a predetermined state of the art level of outlier points, where the outlier points themselves represent the valuation variance below and above predetermined values, which points have been multiplied by a multiplier based on the size or magnitude of said values, and wherein said outlier points that represent positive outliers are further multiplied by an additional positive outlier amplifier.

45. A computer-based apparatus for calculating an automated valuation rank, comprising:
temporary data storage means for storing relevant data;
input means connected to said temporary data storage means for receiving new data on at least one property;
automated valuation model connection means connected to said temporary data storage means for requesting automated valuation model valuations of said at least one property; and
calculation means connected to said temporary data storage means for calculating an automated valuation model rating based on. two or more of the following indicators of precision:
a) a hit score
b) a useful hit score
c) a centrality score
d) an accuracy score
e) an outlier score
said calculation means also used for calculating the automated valuation model rank based upon said automated valuation model rating.

46. The apparatus of claim 45, wherein said indicators of precision are said useful hit score, said centrality score, said accuracy score and said outlier score.

47. The apparatus of claim 46, wherein said indicators of precision are applied in the order they are listed.

48. The apparatus of claim 46, wherein said indicators of precision are applied without reference to a predetermined order.

49. The apparatus of claim 45, wherein said indicators of precision are said centrality score, said accuracy score and said outlier score.

50. The apparatus of claim 49, wherein said indicators of precision are applied in the order they are listed.

51. The apparatus of claim 49, wherein said indicators of precision are applied without reference to a predetermined order.
